(19) United States
(12) Patent Application Publication
(10) Pub. No.: US 2026/0269126 A1
(43) Pub. Date: Sep. 10, 2026

(54) DIELECTRIC CERAMIC COMPOSITION AND MULTILAYER CERAMIC ELECTRONIC COMPONENT

(71) Applicant: TAIYO YUDEN CO., LTD., Tokyo (JP)

(72) Inventors: Yuta SAITO, Tokyo (JP); Keiichi HATANO, Tokyo (JP); Yuji TSUSHIMA, Tokyo (JP)

(73) Assignee: TAIYO YUDEN CO., LTD., Tokyo (JP)

(21) Appl. No.: 19/167,335

(22) PCT Filed: Mar. 12, 2024
(86) PCT No.: PCT/JP2024/009537

§ 371 Date: Sep. 19, 2025

(30) Foreign Application Priority Data
Mar. 29, 2023 (JP) 2023-053844

(51) Int. Cl. H01G 4/12; C04B 35/468; H01G 4/008; H01G 4/012; H01G 4/30

(52) U.S. Cl. CPC H01G 4/1227; C04B 35/4682; H01G 4/008; H01G 4/012; C04B 2235/3206; C04B 2235/3224; C04B 2235/3234; C04B 2235/3262; C04B 2235/3418; H01G 4/30

(57) ABSTRACT

A dielectric ceramic composition includes a main phase that contains barium titanate with a perovskite structure, a first crystal grain that contains barium, titanium and magnesium, and satisfies 5.00≤a≤7.00 and 0.50≤b≤1.50, where a is an elemental ratio of titanium to barium content, and b is an elemental ratio of magnesium to barium content, and a second crystal grain that contains barium, titanium, magnesium, manganese and nickel, and satisfies 1.50≤c≤3.50, 0.03≤d≤0.30, 0.03≤e≤0.30, and 0.03≤f≤0.40, where an elemental ratio of titanium to barium content is c, an elemental ratio of magnesium to barium content is d, an elemental ratio of manganese to barium content is e, and an elemental ratio of nickel to barium content is f.

### TECHNICAL FIELD

The present invention relates to a dielectric ceramic composition and a multilayer ceramic electronic component.

### BACKGROUND ART

Multilayer ceramic electronic components such as multilayer ceramic capacitors (MLCC: Multi-Layer ceramic capacitor) are used in high frequency communication systems such as mobile phones.

### RELATED ART DOCUMENT

### Patent Document

Patent Document 1: Japanese Patent Application Laid-Open Publication No. 2012-131669
Patent Document 2: Japanese Patent Application Laid-Open Publication No. 2016-153359

### SUMMARY OF THE INVENTION

### Problems to be Solved by the Invention

As the dielectric ceramic composition used for the dielectric layer of multilayer ceramic electronic components, a sintered body with a core-shell structure in which barium titanate is used as a core part and a shell part containing various additives as a solid solution surrounds the core part has been used. By adopting this structure, due to the effects of the various additives, it is possible to shift exhibition of a large capacitance in the shell part that would occur near the Curie temperature where barium titanate changes from the ferroelectric phase to the paraelectric phase, which exists around 125° C., to a lower temperature range, thereby making it possible to produce designs that have increased capacitances in the practical temperature range near room temperature.

As an application example of barium titanate without a core-shell structure, a piezoelectric ceramic that contains, as a barium titanate complex oxide, at least one of Ba₄Ti₁₂O₂₇ or Ba₆Ti₁₇O₄₀ and that contains 0.04% to 0.20% by mass or less of manganese with respect to barium titanate has been disclosed (see, for example, Patent Document 1).

Further, a piezoelectric ceramic that contains a metal oxide represented by (Ba₁₋ₓCaₓ)ₐ (Ti_{1-y}Zr_{y})O₃ (where 0.09≤x≤0.30, 0.025≤y≤0.085, 0.986≤a≤1.020) and 0.04 parts by weight or more and 0.36 parts by weight or less of manganese based on 100 parts by weight of the metal oxide, and that contains, as a barium titanate complex oxide, at least one metal oxide selected from BaTi₂O₅, BaTi₄O₉, BaTi₅O₁₁, BaTi₆O₁₃, BaTi₇O₁₄, BaTi₈O₁₆, Ba₂Ti₅O₁₂, Ba₂Ti₆O₁₃, Ba₂Ti₉O₂₀, Ba₄Ti₁₁O₂₆, Ba₄Ti₁₃O₃₀, CaTi₂O₄, CaTi₂O₅, CaTi₄O₉, Ca₂Ti₅O₁₂, CaZr₄O₉, Ca₂Zr₇O₁₆, Ca₆Zr₁₉O₄₄, CaZrTi₂O₇, and Ca₂Zr₅Ti₂O₁₆ has been disclosed (see, for example, Patent Document 2).

When trying to apply the piezoelectric ceramics disclosed in Patent Document 1 and Patent Document 2 to a dielectric ceramic composition used in the dielectric layer of a multilayer ceramic electronic component, it has been realized, as described in Patent Documents 1 and 2, that the maximum grain size of crystal grains becomes 2 μm or more, and it has been found that for multilayer ceramic electronic components where the dielectric layer is 10 μm or less, the number of grain boundaries is reduced and a problem arose in that the insulation properties are significantly deteriorated.

In recent years, the use of multilayer ceramic electronic components has been expanding, even in electronic circuits affecting human life, such as in-vehicle electronic control devices. Because of this, it became necessary to ensure high insulation resistance.

The present invention was made in view of the above appreciations of the problems in the art, and an object of the present invention is to provide a dielectric ceramic composition and a multilayer ceramic electronic component that can achieve high insulation resistance.

### Means for Solving the Problems

A dielectric ceramic composition according to the present invention includes: a main phase that contains barium titanate with a perovskite structure; a first crystal grain that contains barium, titanium and magnesium, and satisfies 5.00≤a≤7.00 and 0.50≤b≤1.50 when a is an elemental ratio of titanium to barium content, and b is an elemental ratio of magnesium to barium content; and a second crystal grain that contains barium, titanium, magnesium, manganese and nickel, and satisfies 1.50≤c≤3.50, 0.03≤d≤0.30, 0.03≤e≤0.30, and 0.03≤f≤0.40 when an elemental ratio of titanium to barium content is c, an elemental ratio of magnesium to barium content is d, an elemental ratio of manganese to barium content is e, and an elemental ratio of nickel to barium content is f.

In the above-mentioned dielectric ceramic composition, the first crystal grain may further contain manganese and nickel, and the first crystal grain may satisfy 0.10≤g≤4.00 and 0.10≤h≤4.00 when an elemental ratio of manganese to barium content is g and an elemental ratio of nickel to barium content is h.

The above-mentioned dielectric ceramic composition may further include a third crystal grain that contains at least one of silicate, enstatite, barium magnesium silicate, or fresnoite.

In the above-mentioned dielectric ceramic composition, the first crystal grain and the second crystal grain may be located in a grain boundary of the main phase.

In the above-mentioned dielectric ceramic composition, the first crystal grain and the second crystal grain may be located at a triple junction of grain boundaries of the main phase.

In the above-mentioned dielectric ceramic composition, the third crystal grain may be located in a grain boundary of the main phase.

In the above-mentioned dielectric ceramic composition, the third crystal grain may be located on a triple junction of grain boundaries of the main phase.

In the above-mentioned dielectric ceramic composition, the main phase may include a core portion and a shell portion surrounding the core portion.

In the above-mentioned dielectric ceramic composition, the shell portion may include a rare earth element.

In the above-mentioned dielectric ceramic composition, an elemental ratio of barium to titanium content may be 0.940 or more and 0.980 or less, an elemental ratio of gadolinium to titanium content may be 0.005 or more and 0.05 or less, and an elemental ratio of magnesium to titanium content may be 0.002 or more and 0.02 or less.

Another dielectric ceramic composition according to the present invention includes: a main phase having a perovskite structure, containing barium titanate, and having a core portion and a shell portion surrounding the core portion; and a first crystal grain containing barium, titanium, and magnesium, and satisfies 5.00≤a≤7.00 and 0.50≤b≤1.50 when a is an elemental ratio of titanium to barium content, and b is an elemental ratio of magnesium to barium content,

In the above-mentioned dielectric ceramic composition, the first crystal grain may further contain manganese and nickel, and the first crystal grain may satisfy 0.10≤g≤4.00 and 0.10≤h≤4.00, when an elemental ratio of manganese to barium content is g and an elemental ratio of nickel to barium content is h.

A multilayer ceramic electronic device according to the present invention includes: a plurality of dielectric layers including the above-mentioned dielectric ceramic composition; a plurality of internal electrodes facing each other with the plurality of dielectric layers interposed therebetween; and external electrodes that are electrically connected to the plurality of internal electrodes, respectively.

### Effects of the Invention

According to the present invention, it is possible to provide a dielectric ceramic composition and a multilayer ceramic electronic component that can achieve high insulation characteristics.

### BRIEF DESCRIPTION OF THE DRAWINGS

FIG. 1 is a diagram illustrating a dielectric ceramic composition according to a first embodiment.

FIG. 2 is a diagram illustrating a unit cell.

FIG. 3 is a partial cross-sectional perspective view of a multilayer ceramic capacitor.

FIG. 4 is a sectional view taken along the line A-A in FIG. 3.

FIG. 5 is a sectional view taken along the line B-B in FIG. 3.

FIG. 6 is a diagram illustrating a flow of a method for manufacturing a multilayer ceramic capacitor.

FIG. 7(a) and FIG. 7(b) are diagrams illustrating an internal electrode forming process.

FIG. 8 is a figure which illustrates a crimping process.

FIG. 9 is a figure which illustrates side margin parts.

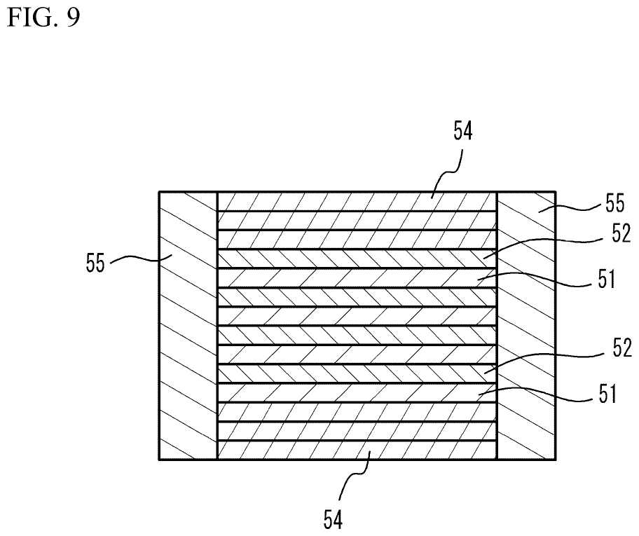

### DETAILED DESCRIPTION OF EMBODIMENTS

Hereinafter, embodiments will be described with reference to the drawings.

### First Embodiment

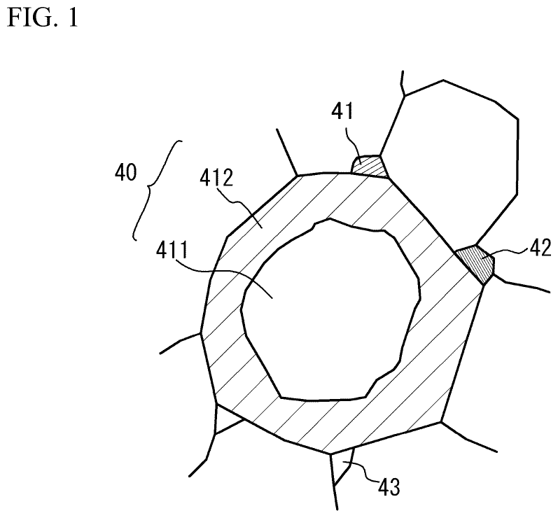

The dielectric ceramic composition according to the first embodiment is a ceramic polycrystalline body containing crystal grains having a perovskite structure represented by the general formula ABO₃. As illustrated in FIG. 1, these ceramic polycrystalline bodies contain a main phase crystal grain 40 and a first crystal grain 41.

The main phase crystal grains 40 contain barium titanate having a perovskite structure.

The first crystal grain 41 contains barium, titanium, and magnesium, and when the elemental ratio of titanium to the barium content is a (hereinafter also referred to as Ti/Ba elemental ratio a) and the elemental ratio of magnesium to the barium content is b (hereinafter also referred to as Mg/Ti elemental ratio b), the following relationship is satisfied: 5.00≤a≤7.00, and 0.50≤b≤1.50.

For example, when a cross section of the dielectric ceramic composition is observed in a field of view where a total of 400 or more of the main phase crystal grains 40 and the first crystal grains 41 can be confirmed, the area ratio of the main phase crystal grains 40 is 50.0% or more and 99.95% or less, and the area ratio of the first crystal grains 41 is 0.050% or more and 45.0% or less.

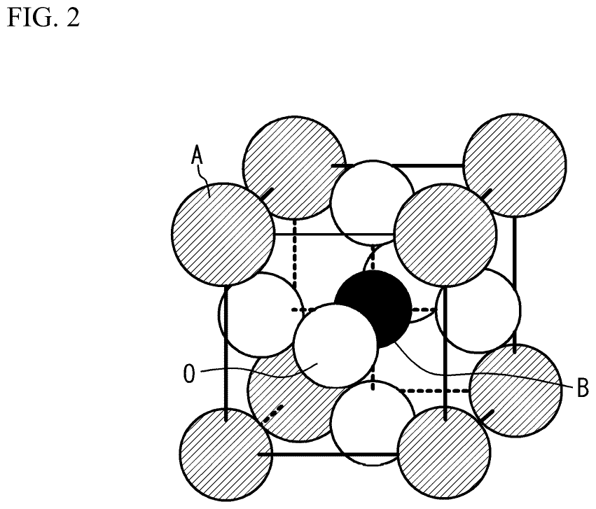

Crystal grains having a perovskite structure, which are the main components of the first crystal grains 41, have a unit cell as illustrated in FIG. 2. This unit cell has the A site located at the apex of the lattice, the O site located at the face center of the lattice, and the B site located within an octahedron with the O site as the apex. In the perovskite structure, alkaline earth metals that can take divalent cations such as barium (Ba), strontium (Sr), and calcium (Ca) are located at the A site, and hafnium (Hf) and zirconium (Zr) are located at the B site, titanium (Ti), and other metal atoms that can form tetravalent cations.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.98≤a≤1.01 and 0≤β≤0.20 are allowed.

However, due to the generation of oxygen defects, for example, the resistivity decreases and ionic conductivity is exhibited, which reduces the electrical life when used as a multilayer ceramic capacitor and increases the dielectric loss, which in turns make it not practical for use. For this reason, at least one of the alkaline earth elements magnesium (Mg), calcium (Ca), strontium (Sr), or barium (Ba) may be added to the main phase crystal grains 40 having a perovskite structure as necessary, which can improve the resistivity, increase the electrical longevity, and reduce the dielectric loss relative to the capacitance.

Also, if necessary, the main phase crystal grains 40 may contain at least one of the first transition element: scandium (Sc), titanium (Ti), vanadium (V), chromium (Cr), iron (Fe), cobalt (Co), nickel (Ni), copper (Cu), or zinc (Zn). This can improve resistivity, increase electrical longevity, and reduce dielectric loss relative to capacitance.

In addition, the main phase crystal grains 40 may include at least one of the second transition elements such as yttrium (Y), zirconium (Zr), niobium (Nb), molybdenum (Mo), ruthenium (Ru), rhodium (Rh), palladium (Pd) or silver (Ag). This makes it possible to improve resistivity, extend electrical life, and reduce dielectric loss of capacitance.

In addition, the main phase crystal grains 40 may include at least one of the third transition elements such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), or gold (Au). This makes it possible to improve resistivity, extend electrical life, and reduce dielectric loss of capacitance.

By using at least one of the above-mentioned alkaline earth element, the first transition metal element, the second transition metal element, and the third transition metal element as an additive, at least one of the alkaline earth element, the first transition metal element, the second transition metal element, and the third transition metal element can be solid-dissolved from the interface of the main phase crystal grain 40 to the inside in the firing temperature range of 1000° C. to 1400° C. for obtaining the dielectric ceramic composition, and a core portion 411 and a shell portion 412 can be generated in the main phase crystal grain 40. For example, it is preferable to add 0.25 mol or more and 2.5 mol or less of gadolinium in terms of gadolinium oxide (Gd₂O₃) to 100 mol of barium titanate so that the Gd/Ti elemental ratio j, which is the elemental ratio of gadolinium to the barium content, is 0.005≤j≤0.05. In addition to the addition of gadolinium oxide, it is preferable to add 0.2 mol or more and 2.0 mol or less in terms of magnesium oxide (MgO) to 100 mol of barium titanate so that the Mg/Ti elemental ratio k, which is the magnesium elemental ratio to the barium content, is 0.0025≤k≤0.05. For example, when 0.005≤j≤0.05 and 0.0025≤k≤0.02 are satisfied, the added gadolinium, manganese, and titanium react on the surface of the barium titanate crystal grain, and can be generated as a shell portion in the form of a composite perovskite compound considered to be Gd(Ti,Mg)O₃. As a result, the dielectric ceramic composition can suppress the movement of oxygen defects in the grain boundaries and inside the shell portion, suppress the decrease in resistivity, and improve the electrical life.

Generally, in the core-shell structure, as the firing temperature increases, more of various additives are solid-dissolved in the crystal grains made of barium titanate, and the shell portion 412 tends to become thicker, and the grain size of the core portion 411 tends to become smaller. In the shell portion 412, an acceptor element having a smaller valence than titanium, such as magnesium, is solid-dissolved as a B-site element, thereby suppressing the reduction of titanium during reduction firing and improving the insulation resistance. Therefore, as an example, in order to ensure high insulation resistance of the multilayer ceramic capacitor, it is necessary to solid-dissolve the acceptor element in the shell portion 412.

However, when the acceptor element is solid-dissolved in the shell portion 412, oxygen defects are generated, which may reduce the electrical life and reliability. Therefore, in order to achieve both high insulation resistance and high reliability, it is necessary to precisely control the amount of the acceptor element solid-dissolved in the shell portion 412.

The dielectric ceramic composition according to this embodiment includes, in addition to the main phase crystal grains 40 containing barium titanate having a perovskite structure, the first crystal grains 41 that satisfy 5.00≤Ti/Ba elemental ratio a≤7.00 and 0.50≤Mg/Ba elemental ratio b≤1.50. By intentionally precipitating the first crystal grains 41 as in this configuration, high reliability can be achieved and high insulation resistance can be achieved. The Ti/Ba elemental ratio a is preferably 5.15 or more, and more preferably 5.40 or more, which can achieve high insulation resistance. Moreover, the Ti/Ba elemental ratio a is preferably 6.85 or less, and more preferably 6.60 or less to malize high insulation resistance. The Mg/Ba elemental ratio b is preferably 0.60 or more, and more preferably 0.75 or more to malize high insulation resistance. The Mg/Ba elemental ratio b is preferably 1.40 or less, and more preferably 1.25 or less to malize high insulation resistance.

The first crystal grain 41 may further contain manganese and nickel, and when the elemental ratio of manganese to the barium content is g (hereinafter also referred to as Mn/Ba elemental ratio g), and the elemental ratio of nickel to the barium content is h (hereinafter also referred to as Ni/Ba elemental ratio h), it is preferable that 0.10≤g≤4.00 and 0.10≤h≤4.00 are satisfied. This is because the decrease in resistivity of the dielectric ceramic composition can be suppressed. The Mn/Ba elemental ratio g is more preferably 0.50 or more, and more preferably 1.00 or more to realize high insulation resistance. The Mn/Ba elemental ratio g is more preferably 3.75 or less, and more preferably 3.50 or less to malize high insulation resistance. The Ni/Ba elemental ratio h is preferably 0.50 or more, and more preferably 1.00 or more to realize high insulation resistance. The Ni/Ba elemental ratio h is preferably 3.75 or less, and more preferably 3.50 or less to malize high insulation resistance.

The first crystal grain 41 may contain at least one of calcium, scandium, vanadium, chromium, iron, cobalt, nickel, copper, zinc, yttrium, zirconium, niobium, or molybdenum. This is because the decrease in resistivity of the dielectric ceramic composition can be suppressed.

The presence of the first crystal grain 41 in the dielectric ceramic composition can be confirmed by the following procedure.

First, the surface of the dielectric ceramic composition is exposed. There are no particular limitations on the method of exposure, and methods such as cutting or polishing the element can be used. At this time, in order to fully observe the internal ceramic structure, it is preferable to finally obtain a smoothness that can be judged as a mirror surface using diamond paste or the like of 2 microns or less. The method of cutting or polishing the element is suitable for observation by SEM. Furthermore, a thin piece with a thickness of 100 nm or less can be obtained from the surface of the dielectric ceramic composition having the smoothness that can be judged as a mirror surface using an ion beam or the like. The thin piece is suitable for observation by STEM.

Next, an energy dispersive X-ray spectrometer (EDS) or a wavelength dispersive X-ray spectrometer (WDS), which is attached to a scanning electron microscope (SEM) or transmission electron microscope (TEM), or an electron probe microanalyzer (EPMA), or a laser irradiation inductively coupled plasma mass spectrometry (LA-ICP-MS) or the like is used to analyze the composition of the first crystal grain 41.

For example, in EDS measurement, simply, the K-line intensity of titanium relative to the K-line or L-line of barium or the K-line of manganese can be used to analyze the composition. More specifically, from these intensities, a correction (ZAF correction) is performed that takes into account the atomic number effect, absorption effect, and fluorescence excitation effect, and the ratio of each to the elemental content of barium is calculated, and the ratio of each element is calculated.

When performing EDS measurements, especially when using barium's Lα ray and titanium's Kα ray, their energy peaks are close to each other, and it may be difficult to adequately compare the element contents. For this mason, it is desirable that the Lβ2 line and LIIIab ray of barium, which do not have peak overlap, be obtained with sufficient intensity for the measurement. Specifically, it is preferable that the intensity at the peak is 10,000 counts or more. This way, the intensity of the characteristic X-rays from barium can be determined and the element content can be calculated, so even if the Lα line of barium and the Kα line of Ti overlap, the intensity of the Kα rays of titanium can be determined, and the element content can be evaluated with high accuracy.

When a crystal grain obtained by the above method is confirmed to have a Ti/Ba elemental ratio a of 5.00 to 7.00 and a Mg/Ba elemental ratio b of 0.50 to 1.50, the crystal grain can be determined to be the first crystal grain 41. In other words, the first crystal grain 41 is determined to be a barium titanate composite oxide because the elemental ratio of titanium and magnesium to barium is larger than that of the main phase crystal grain 40 made of barium titanate that exists around the first crystal grain 41. In this case, when an SEM is used for observation, the first crystal grain 41 is characterized by being observed to have a relatively low brightness and to be darker than the main phase crystal grain 40 in observation by a backscattered electron image (BSE image). Furthermore, when an STEM is used for observation, the first crystal grain 41 is characterized by being observed to have a relatively low brightness and appear darker than the main phase crystal grain 40 in a high-angle annular dark-field scanning transmission electron microscopy image (HAADF-STEM image).

The manganese content and nickel content of the first crystal grain 41 are quantified by simply using the manganese K-ray intensity and nickel K-ray intensity relative to the barium K-ray or L-ray. More specifically, a corrections (ZAF correction) is made from these intensities, taking into account the atomic number effect, absorption effect, and fluorescence excitation effect, and the ratio of each relative to the barium element content is calculated to obtain the ratio of each element. Furthermore, if the grain size of the first crystal grain 41 is smaller than the spatial resolution of the EDS analysis with the SEM, it is preferable to observe the first crystal grain 41 with a scanning transmission electron microscope (STEM) and identify the composition of the first crystal grain 41 with EDS.

As illustrated in FIG. 1, the dielectric ceramic composition preferably contains a second crystal grain 42 in addition to the main phase crystal grain 40 and the first crystal grain 41. The second crystal grain 42 contains barium, titanium, magnesium, manganese, and nickel, and when the elemental ratio of titanium to barium content is c (hereinafter also referred to as Ti/Ba elemental ratio c), the elemental ratio of magnesium to barium content is d (hereinafter also referred to as Mg/Ba elemental ratio d), the elemental ratio of manganese to barium content is e (hereinafter also referred to as Mn/Ba elemental ratio e), and the elemental ratio of nickel to barium content is f (hereinafter also referred to as Ni/Ba elemental ratio f), the second crystal grain 42 satisfies the following conditions: 1.50≤Ti/Ba elemental ratio c≤3.50, 0.03≤Mg/Ba elemental ratio d≤0.30, 0.03≤Mn/Ba elemental ratio e≤0.30, and 0.03≤Ni/Ba elemental ratio f≤0.40.

For example, when a cross section of the dielectric ceramic composition is observed in a field of view where a total of 400 or more of the main phase crystal grains 40, the first crystal grains 41, and the second crystal grains 42 are confirmed, the area ratio of the main phase crystal grains 40 is 50.0% or more and 99.95% or less, the area ratio of the first crystal grains 41 is 0.050% or more and 45.0% or less, and the area ratio of the second crystal grains 42 is 0.050% or more and 15.0% or less.

The second crystal grains 42 are crystal grains that are generated secondarily when an additive containing titanium as a main component is used as an additive. By intentionally precipitating the second crystal grains 42, the main phase crystal grains 40 and the first crystal grains 41 can be obtained, and high insulation resistance can be obtained in a multilayer ceramic capacitor that requires high reliability.

The Ti/Ba elemental ratio c is preferably 1.70 or more, and more preferably 1.90 or more to achieve high insulation resistance. The Ti/Ba elemental ratio c is more preferably 2.70 or less, and more preferably 2.50 or less to achieve high insulation resistance. The Mg/Ba elemental ratio d is preferably 0.05 or more, and more preferably 0.08 or more to achieve high insulation resistance. The Mg/Ba elemental ratio d is preferably 0.25 or less, and more preferably 0.20 or less to achieve high insulation resistance. The Mn/Ba elemental ratio e is more preferably 0.05 or more, and more preferably 0.08 or more to achieve high insulation resistance. The Mn/Ba elemental ratio e is more preferably 0.25 or less, and more preferably 0.20 or less to achieve high insulation resistance. The Ni/Ba elemental ratio f is preferably 0.05 or more, and more preferably 0.10 or more to achieve high insulation resistance. The Ni/Ba elemental ratio f is preferably 0.35 or less, and more preferably 0.30 or less to achieve high insulation resistance.

The second crystal grain 42 may further contain at least one of calcium, scandium, vanadium, chromium, iron, cobalt, nickel, copper, zinc, yttrium, zirconium, niobium, or molybdenum. This is because it is possible to suppress a decrease in the resistivity of the dielectric ceramic composition.

The fact that the dielectric ceramic composition contains the second crystal grain 42 can be confirmed by the following procedure.

First, the surface of the dielectric ceramic composition is exposed. This exposure method is not particularly limited, and a method of cutting or polishing the element can be adopted. At this time, in order to fully observe the internal ceramic structure, it is preferable to finally obtain a smoothness that can be judged as a mirror surface using diamond paste or the like of 2 microns or less. The above-mentioned method of cutting or polishing the element is suitable for observation by SEM. Furthermore, a thin piece having a thickness of 100 nm or less can be obtained from the surface of the dielectric ceramic composition having a smoothness that can be judged as a mirror surface using an ion beam or the like. The above-mentioned thin piece is suitable for observation by STEM.

Next, the composition of the second crystal grain 42 is identified using an EDS or WDS attached to the SEM or STEM, EPMA, LA-ICPMS or the like.

For example, in EDS measurements, the elements are simply identified by the K-ray intensity of titanium, magnesium, manganese, and nickel relative to the K-ray or L-ray of barium. More specifically, from these intensities, a correction (ZAF correction) is made that takes into account the atomic number effect, absorption effect, and fluorescence excitation effect, and the ratios of each to the elemental content of barium are calculated to determine the ratios of each element. If the sample thickness is sufficiently thin, for example, less than a few tens of nm, a correction can be made using the proportionality coefficient (K factor) used in the Cliff-Florimer method to determine the ratios of each element. In addition to the correction used in the Cliff-Florimer method, a correction can be made that takes into account the absorption effect of the sample to determine the ratios of each element. The absorption effect of the sample can be corrected by determining the thickness and density of the sample. The thickness of the sample can be determined, for example, by obtaining a convergent-beam electron diffraction (CBED) pattern under two-wave excitation conditions and analyzing the rocking curve observed on a diffraction disk. The grains from which the CBED pattern is obtained can be the main phase crystal grain 40 or the like. The density of the sample can be, for example, 6.02 g/cm³, which is the density of barium titanate.

When performing EDS measurements, especially when using barium's Lα ray and titanium's Kα ray, their energy peaks are close to each other, and it may be difficult to adequately compare the element contents. For this mason, it is desirable that the Lβ2 ray and LIIIab ray of barium, which do not have peak overlap, be obtained with sufficient intensity for the measurement. Specifically, it is preferable that the intensity at the peak is 10,000 counts or more. This way, the intensity of the characteristic X-rays from barium can be determined and the element content can be calculated, so even if the Lα ray of barium and the Kα ray of Ti overlap, the intensity of the Kα rays of titanium can be determined, and the element content can be evaluated with high accuracy.

When crystal grain is confirmed that has the Ti/Ba elemental ratio c of 1.50≤c≤3.50, the Mg/Ba elemental ratio d of 0.03≤d≤0.30, the Mn/Ba elemental ratio e of 0.03≤e≤0.30, and the Ni/Ba elemental ratio f of 0.03≤f≤0.40 obtained by the above method, the crystal grain can be determined to be the second crystal grain 42. That is, the second crystal grain 42 is determined to be barium titanate composite oxide because the elemental ratios of titanium, magnesium, manganese, and nickel to barium are larger than those of the surrounding main phase crystal grain 40 made of barium titanate, and the elemental ratios of titanium, magnesium, manganese, and nickel to barium are smaller than those of the first crystal grain 41. In this case, when an SEM is used for observation, the second crystal grain 42 is characterized by being observed to have a relatively low brightness and is darker than the main phase crystal grain 40 in observation using a backscattered electron image (BSE image). In addition, when an STEM is used for observation, the second crystal grain 42 is characterized by being observed to have a relatively low brightness and darker than the main phase crystal grain 40 in the observation by high-angle annular dark-field scanning transmission electron microscopy image (HAADF-STEM image). In addition, when quantifying the manganese content and nickel content contained in the second crystal grain 42, they are simply quantified by the K-ray intensity of manganese and the K-ray intensity of nickel relative to the K-ray or L-ray of barium. More specifically, from those intensities, a correction (ZAF correction) is performed taking into account the atomic number effect, the absorption effect, and the fluorescence excitation effect, and the ratio of each to the element content of barium is calculated to obtain the ratio of each element. When the sample thickness is sufficiently thin, for example, a few tens of nm or less, correction may be performed using the proportionality coefficient (K factor) used in the Cliff-Lorimer method to obtain the ratio of each element. In addition to the correction used in the Cliff-Lorimer method, correction may be performed taking into account the absorption effect of the sample to obtain the ratio of each element. The absorption effect of the sample can be corrected by determining the thickness and density of the sample. The thickness of the sample can be obtained, for example, by obtaining a convergent-beam electron diffraction (CBED) pattern under two-wave excitation conditions and analyzing the rocking curve observed on a diffraction disk. The grain that obtains the CBED pattern can be the main phase crystal grain 40, or the like. The density of the sample can be, for example, a value such as 6.02 g/cm³, which is the density of barium titanate.

In addition, when the grain size of the second crystal grain 42 is smaller than the spatial resolution in EDS analysis with an SEM, it is desirable to identify the composition of the second crystal grain 42 using a scanning transmission electron microscope (STEM).

The dielectric ceramic composition may contain, in addition to the main phase crystal grain 40, the first crystal grain 41 and the second crystal grain 42, a third crystal grain 43 having a different composition or crystal structure from these, a void 44 or the like. For example, when a cross section of the dielectric ceramic composition is observed in a field of view where a total of 400 or more of the main phase crystal grains 40, the first crystal grains 41, the second crystal grains 42, and the third crystal grains 43 are confirmed, the area ratio of the third crystal grains 43 is 0.050% or more and 15.0% or less.

The third crystal grain 43 is a crystal rain such as silicate (SiO₂), enstatite (MgSiO₃), barium magnesium silicate (BaMgSiO₄), and fresnoite (Ba₂TiSi₂O₈). By including the third crystal grain, the dielectric ceramic composition can be sufficiently densified by firing at 1300° C. or less. Instead of the third crystal grain 43, glass grains such as silicate (SiO₂), enstatite (MgSiO₃), barium magnesium silicate (BaMgSiO₄), and fresnoite (Ba₂TiSi₂O₈) may be included in the dielectric ceramic composition.

In addition to the main phase crystal grain 40, the first crystal grain 41, the second crystal grain 42 and the third crystal grain 43, the dielectric ceramic composition may contain secondary compounds derived from added substances or from electrodes, such as geikierite (MgTiO₃), manganese nickel oxide ((Mn,Ni)O), and pyrophanite (MnTiO₃).

As illustrated in FIG. 1, the first crystal grain 41 and the second crystal grain 42 are preferably located in the grain boundaries of the main phase crystal grains 40. This is because a decrease in the resistivity of the dielectric ceramic composition can be suppressed.

The first crystal grain 41 and the second crystal grain 42 are preferably located on the grain boundary triple junction of the main phase crystal grains 40. This is because a decrease in the resistivity of the dielectric ceramic composition can be suppressed. The grain boundary triple junction is the boundary of three crystal grain boundaries.

The third crystal grain 43 is preferably located in the grain boundaries of the main phase crystal grains 40. This is because it is possible to suppress a decrease in the relative dielectric constant of the dielectric ceramic composition.

The third crystal grains 43 are preferably located on the grain boundary triple junction of the main phase crystal grains 40. This is because this can suppress a decrease in the relative dielectric constant of the dielectric ceramic composition.

The shell portion 412 of the main phase crystal grain 40 preferably contains a rare earth element. This is because this improves the life of the dielectric ceramic composition.

In the main phase crystal grains 40, the first crystal grains 41, the second crystal grains 42, and the third crystal grains 43 as a whole, the elemental ratio of titanium to the barium content is preferably greater than 0.940 and less than 0.980. This is because a sufficient amount of the first crystal grains 41 and the second crystal grains 42 are generated.

### Second Embodiment

As a second embodiment, a multilayer ceramic capacitor 100 using the dielectric ceramic composition according to the first embodiment will be described.

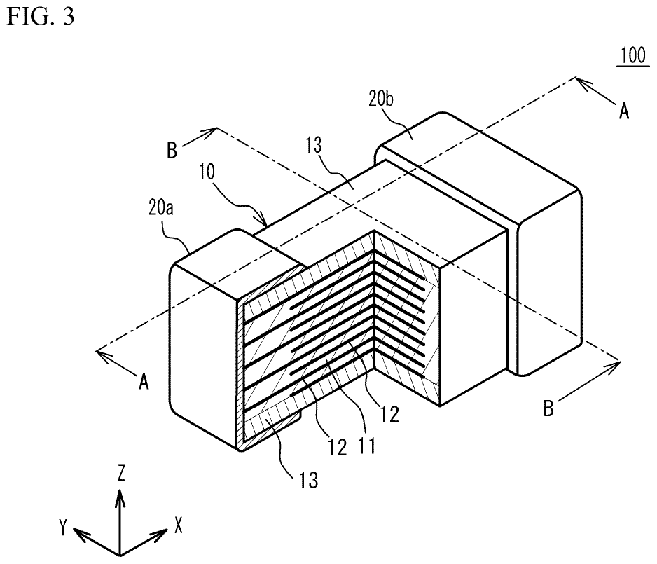

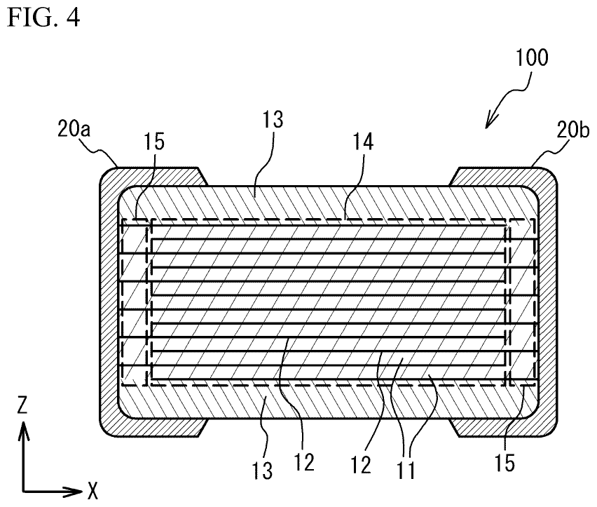

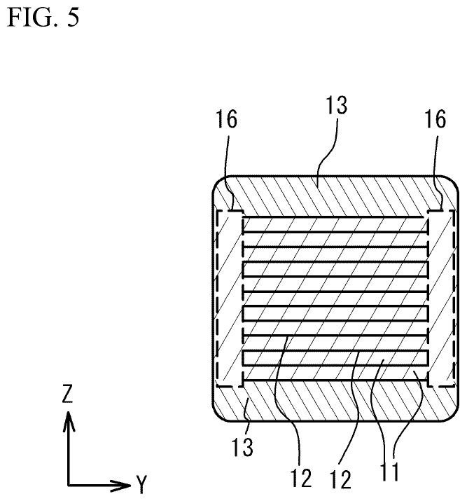

FIG. 3 is a partially cross-sectional perspective view of the multilayer ceramic capacitor 100. FIG. 4 is a cross-sectional view taken along the line A-A in FIG. 3. FIG. 5 is a cross-sectional view taken along the line B-B in FIG. 3. As illustrated in FIG. 3 to FIG. 5, the multilayer ceramic capacitor 100 includes a multilayer chip 10 having a substantially rectangular parallelepiped shape, and external electrodes 20a and 20b provided on two opposing end surfaces of the multilayer chip 10. Note that, of the four surfaces of the multilayer chip 10 other than the two end surfaces, two surfaces other than the upper surface and the lower surface in the stacking direction are referred to as side surfaces. The external electrodes 20a and 20b extend on the top surface, bottom surface, and two side surfaces of the stacked chip 10 in the stacking direction.

However, the external electrodes 20a and 20b are spaced apart from each other.

The multilayer chip 10 has a structure in which dielectric layers 11 containing the dielectric ceramic composition and internal electrode layers 12 containing a base metal material are alternately laminated. The edges of each internal electrode layer 12 are exposed alternately on the end surface where the external electrode 20a of the multilayer chip 10 is provided and the end surface where the external electrode 20b is provided. Thereby, the respective internal electrode layers 12 are alternately electrically connected to the external electrodes 20a and 20b.

As a result, the multilayer ceramic capacitor 100 has a structure in which the plurality of dielectric layers 11 are stacked with the internal electrode layers 12 in between. Further, in the laminate of the dielectric layer 11 and the internal electrode layer 12, the internal electrode layer 12 is disposed as the outermost layer in the stacking direction, and the top and bottom surfaces of the laminate are each covered with cover layers 13. The cover layer 13 has a ceramic material as a main component. For example, the cover layer 13 has the same ceramic main component as the dielectric layer 11.

The size of the multilayer ceramic capacitor 100 is, for example, 0.25 mm long, 0.125 mm wide, and 0.125 mm high, or 0.4 mm long, 0.2 mm wide, and 0.2 mm high, or 0.6 mm long, 0.3 mm wide, and 0.3 mm high, or 1.0 mm long, 0.5 mm wide, and 0.5 mm high, or 3.2 mm long, 1.6 mm wide, and 1.6 mm high, or 4.5 mm high, 3.2 mm side, and 2.5 mm high, but the size is not limited to these.

The internal electrode layer 12 has a base metal such as Ni (nickel), Cu (copper), Sn (tin) as a main component. As the internal electrode layer 12, noble metals such as Pt (platinum), Pd (palladium), Ag (silver), or Au (gold), or alloys containing these metals may be used.

As illustrated in FIG. 4, the section where the internal electrode layer 12 connected to the external electrode 20a and the internal electrode layer 12 connected to the external electrode 20b face each other is a section in which capacitance occurs in the multilayer ceramic capacitor 100. Therefore, the section where the electric capacitance occurs is referred to as a capacitance section 14. That is, the capacitance section 14 is a region where the adjacent internal electrode layers 12 connected to different external electrodes face each other.

The section where the internal electrode layers 12 connected to the external electrode 20a face each other without interposing the internal electrode layer 12 connected to the external electrode 20b is referred to as an end margin 15. Further, the end margin 15 is also a section where the internal electrode layers 12 connected to the external electrode 20b face each other without interposing the internal electrode layer 12 connected to the external electrode 20a. That is, the end margin 15 is a section where the internal electrode layers 12 connected to the same external electrode face each other without interposing the internal electrode layers 12 connected to the other external electrode. The end margin 15 is a section where no capacitance occurs.

As illustrated in FIG. 5, in the multilayer chip 10, the section from the two side surfaces of the multilayer chip 10 reaching the internal electrode layer 12 is referred to as a side margin 16. That is, the side margin 16 is a section provided so as to cover the side ends of the plurality of stacked internal electrode layers 12 extending toward one of the two side surfaces in the stacked structure. The side margin 16 is also a section that does not generate capacitance.

In the multilayer ceramic capacitor 100 according to this embodiment, at least a portion of the dielectric layer 11 in the capacitance section 14 contains the main phase crystal grain 40 and the first crystal grain 41 illustrated in FIG. 1. This makes it possible to achieve high reliability and high insulation resistance.

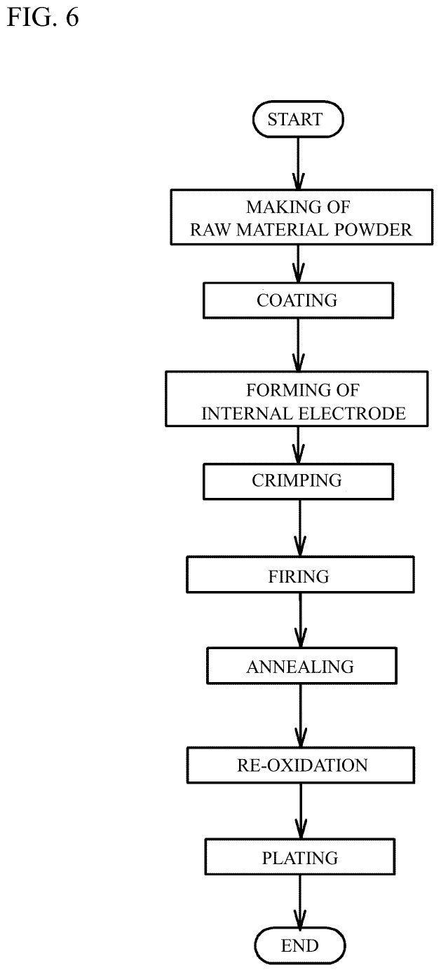

Next, a method for manufacturing the multilayer ceramic capacitor 100 will be described. FIG. 6 is a diagram illustrating a flow of a method for manufacturing the multilayer ceramic capacitor 100.

### (Raw Material Powder Production Process)

First, a dielectric ceramic composition for forming the dielectric layers 11 is prepared.

The A-site element and the B-site element contained in the dielectric layer 11 are usually contained in the dielectric layer 11 in the form of a sintered body of ABO₃ particles. For example, barium titanate is a compound that has a perovskite structure and belongs to the tetragonal system near room temperature, and exhibits a high dielectric constant. This barium titanate can generally be synthesized by reacting a titanium raw material such as titanium dioxide with a barium raw material such as barium carbonate. Various methods are conventionally known for synthesizing barium titanate, which is the main component of the dielectric layer 11, such as a solid phase method, a sol-gel method, and a hydrothermal method. In this embodiment, any of these can be adopted.

Prescribed additives are added to the barium titanate powder obtained by the above method. As an example, additives within the range explained above in the example of the dielectric ceramic composition according to the first embodiment are used. If necessary, an oxide or glass containing Zr (zirconium), V (vanadium), Cr (chromium), Co (cobalt), Ni (nickel), Li (lithium), B (boron), Na (sodium), or K (potassium), may also be used. Also if necessary, an oxide of Sc (scandium), Y (yttrium), La (lanthanum), Ce (cerium), Pr (praseodymium), Nd (neodymium), Pm (promethium), Sm (samarium), Tb (terbium), Dy (dysprosium), Ho (holmium), Er (erbium), Tm (thulium), Y (ytterbium), or Lu (lutetium), as a rare earth element, may be added.

To generate the first crystal grain 41, it is preferable to add 0.002 moles or more and 0.06 moles or less of an additive whose main component is titanium, calculated as titanium oxide (TiO₂), and 0.002 moles or more and 0.05 moles or less of an additive whose main component is magnesium, calculated as magnesium oxide (MgO), to 1 mole of barium titanate. This generates the first crystal grain 41. Instead of titanium oxide, titanium hydroxide (Ti(OH)₄), titanium chloride (TiCl₄), titanium carbide (TiC), titanium sulfide (TiS₂), or the like may be used as the additive whose main component is titanium. Instead of magnesium oxide, magnesium hydroxide (MgOH), magnesium chloride (MgCl₂), magnesium carbonate (MgCO₃), magnesium sulfide (MgS), or the like may be used as the additive whose main component is magnesium.

To generate the second crystal grain 42, it is preferable to add, to 1 mole of barium titanate, an additive whose main component is titanium, in an amount equal to or greater than 0.002 moles and equal to or less than 0.08 moles in terms of titanium oxide (TiO₂), an additive whose main component is magnesium, in an amount equal to or greater than 0.002 moles and equal to or less than 0.05 moles in terms of magnesium oxide (MgO), and an additive whose main component is manganese, in an amount equal to or greater than 0.002 moles and equal to or less than 0.05 moles in terms of manganese carbonate (MnCO₃). This generates the second crystal grain 42. As an additive whose main component is titanium, in addition to titanium oxide, titanium hydroxide (Ti(OH)₄), titanium chloride (TiCl₄), titanium carbide (TiC), titanium sulfide (TiS₂) or the like may also be used. As additives mainly composed of magnesium, magnesium hydroxide (MgOH), magnesium chloride (MgCl₂), magnesium carbonate (MgCO₃), magnesium sulfide (MgS) or the like may be used in addition to magnesium oxide. As additives mainly composed of manganese, manganese monoxide (MnO), manganese trioxide (Mn₃O₄), manganese dioxide (MnO₂) or the like may be used in addition to manganese carbonate.

For example, a compound containing an additive compound may be wet-mixed with barium titanate powder, dried and pulverized to prepare a ceramic material in which barium titanate powder and the additive compound are mixed. For example, if necessary, the ceramic material obtained as described above may be pulverized to adjust the particle diameter, or may be combined with a classification process to adjust the particle diameter. Through the above steps, a dielectric ceramic composition is obtained.

### (Coating Process)

Next, a binder such as polyvinyl butyral (PVB) resin, an organic solvent such as ethanol or toluene, and a plasticizer are added to the obtained dielectric ceramic composition and wet-mixed. Using the obtained slurry, a ceramic green sheet 51 is coated on a base material by, for example, a die coater method or a doctor blade method, and then dried. The base material is, for example, a polyethylene terephthalate (PET) film. Figures illustrating the coating process are omitted.

### (Internal Electrode Formation Process)

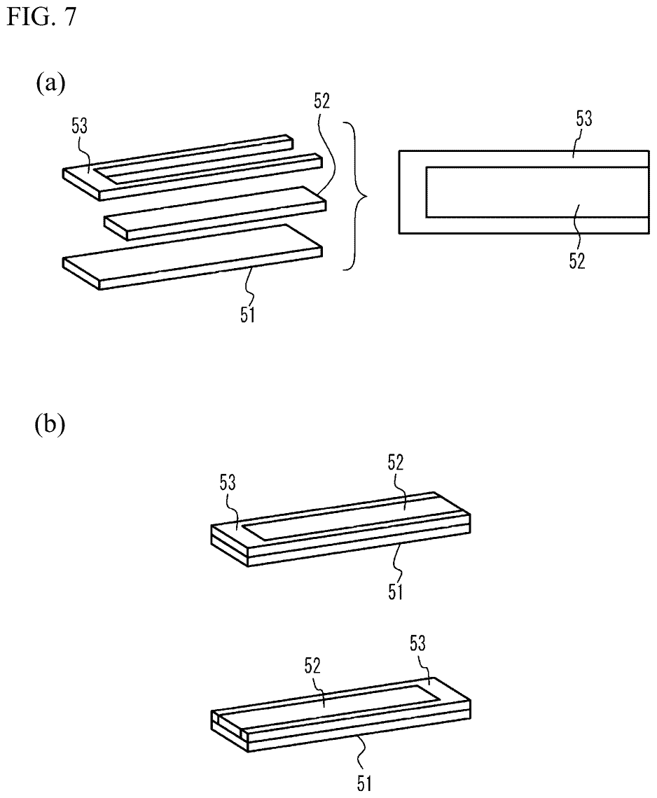

Next, as illustrated in FIG. 7(a), a metal conductive paste containing an organic binder for forming internal electrodes is printed on the surface of the ceramic green sheet 51 by screen printing, gravure printing or the like, to form internal electrode patterns 52 that are to be arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium titanate having an average particle diameter of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 7(a), on the ceramic green sheet 51, a dielectric pattern 53 is arranged by printing a dielectric pattern paste in the peripheral area where the internal electrode pattern 52 is not printed so as to arrange the internal electrode pattern 53, thereby filling in a step with the internal electrode pattern 52. The ceramic green sheet 51 on which the internal electrode pattern 52 and the dielectric pattern 53 are printed is referred to as a stack unit.

Thereafter, as illustrated in FIG. 7(b), the stack units are stacked such that the internal electrode layers 12 and the dielectric layers 11 are arranged alternately, and that the edges of the internal electrode layers 12 are alternately exposed and drawn out alternately to a pair of external electrodes 20a and 20b having different polarities. For example, the number of stacked layers of the internal electrode pattern 52 is set to 100 to 1000 layers.

### (Crimping Process)

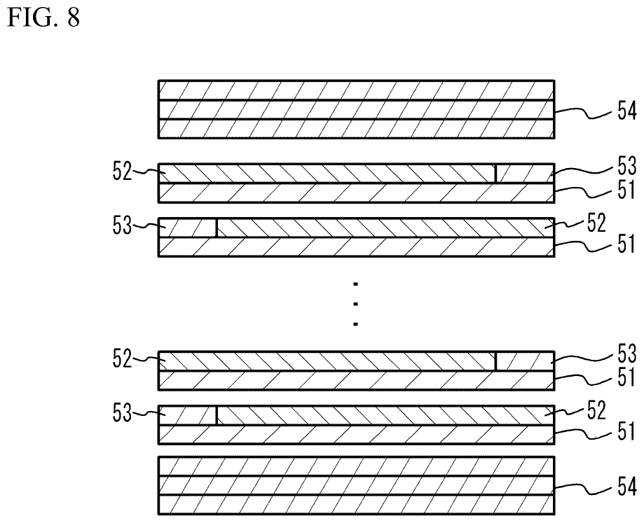

As illustrated in FIG. 8, a predetermined number (for example, 2 to 10 layers) of cover sheets 54 are laminated on top and bottom of the laminate, in which the lamination units have been laminated, and are bonded by thermocompression. As an example of the ceramic material for the cover sheet 54, the dielectric ceramic composition described above can be used. Thereafter, it is cut into a predetermined chip size (for example, 1.0 mm×0.5 mm).

### (Firing Process)

After de-binding the ceramic multilayer body thus obtained in an N₂ atmosphere, air atmosphere, etc., a metal paste that will become the base layer of the external electrodes 20a, 20b is applied by a dip method, and the resulting laminate is fired in a reducing atmosphere of an oxygen partial pressure of 10⁻¹² atm 10⁻⁹ atm at 1100° C. to 1300° C. for 10 minutes to 2 hours. In this manner, the multilayer ceramic capacitor 100 is being obtained. Note that in the firing step, the temperature is rapidly raised. The temperature increase rate in the firing step is, for example, 6000° C./h. This makes it possible to substantially shorten the firing time and achieve higher mass productivity.

### (Annealing Process)

Then, anneal at 900 to 1150° C. for 30 minutes to 2 hours in a reducing atmosphere with an oxygen partial pressure of 10⁻¹² to 10⁻⁹ atm, and slowly cool. The cooling rate is, for example, 200° C./h. In this way, the main phase crystal grains 40 illustrated in FIG. 1 can be formed in at least a portion of the dielectric layer 11 in the capacitance section 14, and the first crystal grains 41 can also be formed.

### (Re-Oxidation Treatment Process)

Thereafter, reoxidation treatment may be performed at 600° C. to 1000° C. in an N₂ gas atmosphere.

### (Plating Process)

Thereafter, a metal coating such as Cu, Ni, Sn and so on is performed on the base layer of the external electrodes 20a, 20b by plating. Through the above steps, the multilayer ceramic capacitor 100 is completed.

According to the manufacturing method of this embodiment, it is possible to form the main phase crystal grains 40 illustrated in FIG. 1 in at least a portion of the dielectric layer 11 in the capacitance section 14, and also to form the first crystal grains 41. This makes it possible to realize high reliability and high insulation resistance.

The DC resistivity ρ (Ω·cm) of the multilayer ceramic capacitor is measured by the following method.

First, the DC current I (nA) is measured for the multilayer ceramic capacitor 100 that has been through the firing, annealing, reoxidation, and plating processes. Next, the capacitance section 14 of the multilayer ceramic capacitor 100 is exposed by cutting or polishing the A-A cross section and the B-B cross section illustrated in FIG. 4 and FIG. 5, and the effective area of the internal electrode layer 12 is calculated when the surface is smooth enough to be considered as a mirror surface using a diamond paste of 2 microns or less. The effective area S is calculated by S=L×W×(N−1), where L is the length L (X-axis direction) and the number of layers N of the internal electrode layer 12 in the capacitance section 14 in FIG. 4, and W is the width W (Y-axis direction) of the internal electrode layer 12 in the capacitance section 14 in FIG. 5. At this time, the thickness of each of the dielectric layers 11 is also measured, and the average thickness t is calculated. At this time, the DC resistivity ρ (0 cm) can be calculated by ρ=V/I×S/t, where V (V) is the DC voltage during measurement.

Note that in each of the above embodiments, a multilayer ceramic capacitor has been described as an example of a multilayer ceramic electronic component, but the present invention is not limited thereto. For example, other multilayer ceramic electronic components such as varistors and thermistors may be used.

### WORKING EXAMPLES

### Working Example 1

Barium titanate powder with an average particle size of 150 nm was prepared, and 0.75 mol of Gd₂O₃, 2.0 mol of TiO₂, 1.5 mol of MnCO₃, 1.0 mol of SiO₂, and 0.5 mol of MgO were added to 100 mol of the barium titanate powder to obtain a dielectric ceramic composition. The Ba/Ti elemental ratio was set to 0.980.

The dielectric ceramic composition was mixed with ethanol, toluene, and PVB (polyvinyl butyral) resin to prepare a dielectric slurry. This slurry was formed into a ceramic green sheet using a die coater and dried. A metal conductive paste containing the main component metal of the internal electrode layer 12, a co-material, a binder (ethyl cellulose), a solvent, and other auxiliary agents as necessary was prepared using a planetary ball mill and screen printed on a ceramic green sheet. Eleven stack units on which a metal conductive paste was printed on a ceramic green sheet were stacked, and cover sheets were stacked on the top and bottom of each multilayer body. Then, a multilayer body was obtained by thermocompression bonding, and cut into a predetermined shape. After the obtained multilayer body was de-bindered in an N₂ atmosphere, a metal conductive paste containing a metal filler mainly composed of Ni, a co-material, a binder, a solvent and so on for the base layer was applied to both end faces and each side of the multilayer body, and dried. Then, the metal conductive paste for the base layer was fired at 1300° C. in a reducing atmosphere at the same time as the multilayer body to obtain a sintered body. The temperature rise rate was 6000° C./h. The shape dimensions of the obtained sintered body were length 0.6 mm, width 0.3 mm, and height 0.3 mm. Then, an annealing treatment was performed at 900 to 1150° C. for 1 hour. Then, a re-oxidation treatment was performed at 950° C. Then, a plating treatment was performed to form a Cu-plated layer, a Ni-plated layer, and an Sn-plated layer on the surface of the base layer, and the multilayer ceramic capacitor 100 was obtained. The average thickness of the dielectric layer 11 was 2.0 sm.

### Working Example 2

In Working Example 2, 0.75 mol of Gd₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.962. The firing temperature was 1250° C. The annealing time was 1 hour. The other conditions were the same as in Working Example 1.

### Example 3

In Example 3, 0.75 mol of Gd₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.962. The firing temperature was 1250° C. The annealing time was 0.5 hours. The other conditions were the same as in Working Example 1.

### Working Example 4

In Working Example 4, 0.75 mol of Gd₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.962. The firing temperature was 1250° C. The annealing time was 2 hours. The other conditions were the same as in Working Example 1.

### Working Example 5

In Working Example 5, 0.75 mol of Gd₂O₃, 6.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.943. The firing temperature was 1200° C. The annealing time was 1 hour. The other conditions were the same as in Working Example 1.

### Working Example 6

In Working Example 6, 0.75 mol of Gd₂O₃, 4.0 mol of TiO₂, 1.5 mol of MnCO₃, 1.0 mol of SiO₂, and 0.2 mol of MgO were added to 100 mol of barium titanate powder to obtain a dielectric ceramic composition. The Ba/Ti elemental ratio was 0.962. The firing temperature was 1280° C. The annealing time was 1 hour. The other conditions were the same as in Working Example 1.

### Working Example 7

In Working Example 7, 0.75 mol of Gd₂O₃, 4.0 mol of TiO₂, 1.5 mol of MnCO₃, 1.0 mol of SiO₂, and 1.0 mol of MgO were added to 100 mol of barium titanate powder to obtain a dielectric ceramic composition. The Ba/Ti elemental ratio was 0.962. The firing temperature was 1250° C. The annealing time was 1 hour. The other conditions were the same as in Working Example 1.

### Working Example 8

In Working Example 8, 0.75 mol of Gd₂O₃, 4.0 mol of TiO₂, 1.5 mol of MnCO₃, 1.0 mol of SiO₂, and 2.0 mol of MgO were added to 100 mol of barium titanate powder to obtain a dielectric ceramic composition. The Ba/Ti elemental ratio was 0.962. The firing temperature was 1250° C. The annealing time was 1 hour. The other conditions were the same as in Working Example 1.

### Working Example 9

In Working Example 9, 0.75 mol of Gd₂O₃, 4.0 mol of TiO₂, 1.5 mol of MnCO₃, 0.2 mol of SiO₂, and 0.5 mol of MgO were added to 100 mol of barium titanate powder to obtain a dielectric ceramic composition. The Ba/Ti elemental ratio was 0.962. The firing temperature was 1300° C. The annealing time was 1 hour. The other conditions were the same as in Working Example 1.

### Working Example 10

In working Example 10, 0.75 mol of Gd₂O₃, 4.0 mol of TiO₂, 1.5 mol of MnCO₃, 0.5 mol of SiO₂, and 0.5 mol of MgO were added to 100 mol of barium titanate powder to obtain a dielectric ceramic composition. The Ba/Ti elemental ratio was 0.962. The firing temperature was 1300° C. The annealing time was 1 hour. The other conditions were the same as in Working Example 1.

### Working Example 11

In Working Example 11, 0.75 mol of Gd₂O₃, 4.0 mol of TiO₂, 1.5 mol of MnCO₃, 2.0 mol of SiO₂, and 0.5 mol of MgO were added to 100 mol of barium titanate powder to obtain a dielectric ceramic composition. The Ba/Ti elemental ratio was 0.962. The firing temperature was 1200° C. The annealing time was 1 hour. The other conditions were the same as in Working Example 1.

### Working Example 12

In Working Example 12, 0.75 mol of Gd₂O₃, 4.0 mol of TiO₂, 5.0 mol of MnCO₃, 0.5 mol of SiO₂, and 0.5 mol of MgO were added to 100 mol of barium titanate powder to obtain a dielectric ceramic composition. The Ba/Ti elemental ratio was 0.962. The firing temperature was 1300° C. The annealing time was 0.5 hours. The other conditions were the same as in Working Example 1.

### Example 13

In Example 13, 0.75 mol of Gd₂O₃, 4.0 mol of TiO₂, 0.2 mol of MnCO₃, 0.5 mol of SiO₂, and 0.5 mol of MgO were added to 100 mol of barium titanate powder to obtain a dielectric ceramic composition. The Ba/Ti elemental ratio was 0.962. The firing temperature was 1300° C. The annealing time was 2 hours. The other conditions were the same as in Working Example 1.

### Comparative Example 1

In Comparative Example 1, 0.75 mol of Gd₂O₃, 1.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.990. The firing temperature was 1320° C. The annealing time was 2 hours. The other conditions were the same as in Working Example 1.

### Comparative Example 2

In Comparative Example 2, 0.75 mol of Gd₂O₃, 8.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.926. The firing temperature was 1160° C. The annealing time was 1 hour. The other conditions were the same as in Working Example 1.

### Comparative Example 3

In Comparative Example 3, 0.75 mol of Gd₂O₃, 4.0 mol of TiO₂, 1.5 mol of MnCO₃, 1.0 mol of SiO₂, and 0.05 mol of MgO were added to 100 mol of barium titanate powder to obtain a dielectric ceramic composition. The Ba/Ti elemental ratio was 0.962. The firing temperature was 1300° C. The annealing time was 1 hour. The other conditions were the same as in Working Example 1.

### Comparative Example 4

In Comparative Example 4, 0.75 mol of Gd₂O₃, 4.0 mol of TiO₂, 1.5 mol of MnCO₃, 1.0 mol of SiO₂, and 5.0 mol of MgO were added to 100 mol of barium titanate powder to obtain a dielectric ceramic composition. The Ba/Ti elemental ratio was 0.962. The firing temperature was 1200° C. The annealing time was 1 hour. The other conditions were the same as in Working Example 1.

### Comparative Example 5

In Comparative Example 5, 0.75 mol of Gd₂O₃, 4.0 mol of TiO₂, 1.5 mol of MnCO₃, 1.0 mol of SiO₂, and 0.5 mol of MgO were added to 100 mol of barium titanate powder to obtain a dielectric ceramic composition. The Ba/Ti elemental ratio was 0.962. The firing temperature was 1250° C. The annealing time was 0 hours. In other words, no annealing treatment was performed. The other conditions were the same as in Working Example 1.

The conditions for Working Examples 1 to 13 and Comparative Examples 1 to 5 are shown in Table 1.

TABLE 1

| | | | | | | | FIRING | TIME |
|---|---|---|---|---|---|---|---|---|
| | | | | | | | TEMPER- | FOR AN- |
| | ADDED AMOUNT (mol) | | | | | | ATURE | NEALING |
| | Gd₂O₃ | TiO₂ | MnCO₃ | SiO₂ | MgO | Ba/Ti | (° C.) | (Hr) |
| EXAMPLE 1 | 0.75 | 2.0 | 1.5 | 1.0 | 0.5 | 0.980 | 1300 | 1 |
| EXAMPLE 2 | 0.75 | 4.0 | 1.5 | 1.0 | 0.5 | 0.962 | 1250 | 1 |
| EXAMPLE 3 | 0.75 | 4.0 | 1.5 | 1.0 | 0.5 | 0.962 | 1250 | 0.5 |
| EXAMPLE 4 | 0.75 | 4.0 | 1.5 | 1.0 | 0.5 | 0.962 | 1250 | 2 |
| EXAMPLE 5 | 0.75 | 6.0 | 1.5 | 1.0 | 0.5 | 0.943 | 1200 | 1 |
| EXAMPLE 6 | 0.75 | 4.0 | 1.5 | 1.0 | 0.2 | 0.962 | 1280 | 1 |
| EXAMPLE 7 | 0.75 | 4.0 | 1.5 | 1.0 | 1.0 | 0.962 | 1250 | 1 |
| EXAMPLE 8 | 0.75 | 4.0 | 1.5 | 1.0 | 2.0 | 0.962 | 1250 | 1 |
| EXAMPLE 9 | 0.75 | 4.0 | 1.5 | 0.2 | 0.5 | 0.962 | 1300 | 1 |
| EXAMPLE 10 | 0.75 | 4.0 | 1.5 | 0.5 | 0.5 | 0.962 | 1300 | 1 |
| EXAMPLE 11 | 0.75 | 4.0 | 1.5 | 2.0 | 0.5 | 0.962 | 1200 | 1 |
| EXAMPLE 12 | 0.75 | 4.0 | 5.0 | 0.5 | 0.5 | 0.962 | 1300 | 0.5 |
| EXAMPLE 13 | 0.75 | 4.0 | 0.2 | 0.5 | 0.5 | 0.962 | 1300 | 2 |
| COMPARATIVE | 0.75 | 1.0 | 1.5 | 1.0 | 0.5 | 0.990 | 1320 | 1 |
| EXAMPLE 1 | | | | | | | | |
| COMPARATIVE | 0.75 | 8.0 | 1.5 | 1.0 | 0.5 | 0.926 | 1160 | 1 |
| EXAMPLE 2 | | | | | | | | |
| COMPARATIVE | 0.75 | 4.0 | 1.5 | 1.0 | 0.05 | 0.962 | 1300 | 1 |
| EXAMPLE 3 | | | | | | | | |
| COMPARATIVE | 0.75 | 4.0 | 1.5 | 1.0 | 5.0 | 0.962 | 1200 | 1 |
| EXAMPLE 4 | | | | | | | | |
| COMPARATIVE | 0.75 | 4.0 | 1.5 | 1.0 | 0.5 | 0.962 | 1250 | 0 |
| EXAMPLE 5 | | | | | | | | |

For each of the multilayer ceramic capacitors of Examples 1 to 13 and Comparative Examples 1 to 5, the direct current I was measured at 150° C. when 60V was applied for 30 seconds using an insulation resistance meter, and the resistivity ρ was calculated. In addition, the presence or absence of the first crystal grain in the dielectric layer that satisfied 5.00≤Ti/Ba elemental ratio a≤7.00 and 0.50≤Mg/Ba elemental ratio b≤1.50 was confirmed. In addition, the Ti/Ba elemental ratio a, Mg/Ba elemental ratio b, Mn/Ba elemental ratio g, and Ni/Ba elemental ratio h in the first crystal grain were measured. Furthermore, the presence or absence of the second crystal grain was confirmed, which had a higher elemental ratio of titanium, magnesium, manganese, and nickel to barium compared to the surrounding main phase crystal grains made of barium titanate, and a lower elemental ratio of titanium, magnesium, manganese, and nickel to barium compared to the first crystal grain. In addition, the Ti/Ba elemental ratio c, the Mg/Ba elemental ratio d, the Mn/Ba elemental ratio e, and the Ni/Ba elemental ratio f in the second crystal grain were measured. The results are shown in Table 2.

In Working Example 1, the first crystal grain could be observed. In the first crystal grain, the Ti/Ba elemental ratio a was 5.32, the Mg/Ba elemental ratio b was 1.00, the Mn/Ba elemental ratio g was 2.28, and the Ni/Ba elemental ratio h was 1.76. In addition, the second crystal grain could be observed. In the second crystal grain, the Ti/Ba elemental ratio c was 1.62, the Mg/Ba elemental ratio d was 0.14, the Mn/Ba elemental ratio e was 0.14, and the Ni/Ba elemental ratio f was 0.18. The resistivity ρ was 2.9×10¹¹ Ω·cm.

In Working Example 2, the first crystal grain could be observed. In the first crystal grain, the Ti/Ba elemental ratio a was 5.60, the Mg/Ba elemental ratio b was 1.11, the Mn/Ba elemental ratio g was 2.85, and the Ni/Ba elemental ratio h was 2.02. In addition, the second crystal grain could be observed. In the second crystal grain, the Ti/Ba elemental ratio c was 2.16, the Mg/Ba elemental ratio d was 0.13, the Mn/Ba elemental ratio e was 0.12, and the Ni/Ba elemental ratio f was 0.20. The resistivity ρ was 9.5×10¹¹ Ω·cm.

In Working Example 3, the first crystal grain could be observed. In the first crystal grain, the Ti/Ba elemental ratio a was 5.66, the Mg/Ba elemental ratio b was 1.14, the Mn/Ba elemental ratio g was 3.42, and the Ni/Ba elemental ratio h was 1.01. In addition, the second crystal grain could be observed. In the second crystal grain, the Ti/Ba elemental ratio c was 2.31, the Mg/Ba elemental ratio d was 0.12, the Mn/Ba elemental ratio e was 0.03, and the Ni/Ba elemental ratio f was 0.37. The resistivity ρ was 2.1×10¹¹ Ωcm.

In Working Example 4, the first crystal grain could be observed. In the first crystal grain, the Ti/Ba elemental ratio a was 5.71, the Mg/Ba elemental ratio b was 1.10, the Mn/Ba elemental ratio g was 1.71, and the Ni/Ba elemental ratio h was 3.03. In addition, no second crystal grains could be observed. The resistivity ρ was 4.1×10¹⁰ Ωcm.

In Example 5, the first crystal grain could be observed. In the first crystal grain, the Ti/Ba elemental ratio a was 6.85, the Mg/Ba elemental ratio b was 1.08, the Mn/Ba elemental ratio g was 0.15, and the Ni/Ba elemental ratio h was 2.10. In addition, the second crystal grain could be observed. In the second crystal grain, the Ti/Ba elemental ratio c was 3.23, the Mg/Ba elemental ratio d was 0.11, the Mn/Ba elemental ratio e was 0.12, and the Ni/Ba elemental ratio f was 0.19. The resistivity ρ was 1.5×10¹¹ Ωcm.

In Working Example 6, the first crystal grain could be observed. In the first crystal grain, the Ti/Ba elemental ratio a was 5.82, the Mg/Ba elemental ratio b was 0.54, the Mn/Ba elemental ratio g was 2.74, and the Ni/Ba elemental ratio h was 2.04. In addition, the second crystal grain could be observed. In the second crystal grain, the Ti/Ba elemental ratio c was 2.20, the Mg/Ba elemental ratio d was 0.03, the Mn/Ba elemental ratio e was 0.12, and the Ni/Ba elemental ratio f was 0.16. The resistivity ρ was 2.0×10¹¹ Ω·cm.

In Example 7, the first crystal grain could be observed. In the first crystal grain, the Ti/Ba elemental ratio a was 5.71, the Mg/Ba elemental ratio b was 1.21, the Mn/Ba elemental ratio g was 2.72, and the Ni/Ba elemental ratio h was 2.02. In addition, the second crystal grain could be observed. In the second crystal grain, the Ti/Ba elemental ratio c was 2.09, the Mg/Ba elemental ratio d was 0.16, the Mn/Ba elemental ratio e was 0.11, and the Ni/Ba elemental ratio f was 0.24. The resistivity ρ was 6.6×10¹¹ Ω·cm.

In Working Example 8, the first crystal grain could be observed. In the first crystal grain, the Ti/Ba elemental ratio a was 5.60, the Mg/Ba elemental ratio b was 1.44, the Mn/Ba elemental ratio g was 2.91, and the Ni/Ba elemental ratio h was 1.94. In addition, the second crystal grain could be observed. In the second crystal grain, the Ti/Ba elemental ratio c was 2.03, the Mg/Ba elemental ratio d was 0.29, the Mn/Ba elemental ratio e was 0.11, and the Ni/Ba elemental ratio f was 0.24. The resistivity ρ was 2.9×10¹¹ Ω·cm.

In Working Example 9, the first crystal grain could be observed. In the first crystal grain, the Ti/Ba elemental ratio a was 5.15, the Mg/Ba elemental ratio b was 0.78, the Mn/Ba elemental ratio g was 2.88, and the Ni/Ba elemental ratio h was 1.96. In addition, the second crystal grain could be observed. In the second crystal grain, the Ti/Ba elemental ratio c was 2.18, the Mg/Ba elemental ratio d was 0.12, the Mn/Ba elemental ratio e was 0.12, and the Ni/Ba elemental ratio f was 0.22. The resistivity ρ was 5.1×10¹¹ Ωcm.

In Working Example 10, the first crystal grain could be observed. In the first crystal grain, the Ti/Ba elemental ratio a was 5.26, the Mg/Ba elemental ratio b was 0.92, the Mn/Ba elemental ratio g was 2.89, and the Ni/Ba elemental ratio h was 2.00. The second crystal grain could be also observed. In the second crystal grain, the Ti/Ba elemental ratio c was 2.24, the Mg/Ba elemental ratio d was 0.12, the Mn/Ba elemental ratio e was 0.12, and the Ni/Ba elemental ratio f was 0.22. The resistivity ρ was 4.9×10¹¹ Ω·cm.

In Working Example 11, the first crystal grain could be observed. In the first crystal grain, the Ti/Ba elemental ratio a was 6.72, the Mg/Ba elemental ratio b was 1.33, the Mn/Ba elemental ratio g was 1.91, and the Ni/Ba elemental ratio h was 1.98. The second crystal grain could be also observed. In the second crystal grain, the Ti/Ba elemental ratio c was 2.22, the Mg/Ba elemental ratio d was 0.12, the Mn/Ba elemental ratio e was 0.12, and the Ni/Ba elemental ratio f was 0.22. The resistivity ρ was 3.9×10¹¹ Ω·cm.

In Working Example 12, the first crystal grin could be observed. In the first crystal grain, the Ti/Ba elemental ratio a was 5.38, the Mg/Ba elemental ratio b was 0.92, the Mn/Ba elemental ratio g was 4.13, and the Ni/Ba elemental ratio h was 0.07. The second crystal grain could be also observed. In the second crystal grain, the Ti/Ba elemental ratio c was 2.76, the Mg/Ba elemental ratio d was 0.12, the Mn/Ba elemental ratio e was 0.02, and the Ni/Ba elemental ratio f was 0.32. The resistivity ρ was 2.3×10¹⁰ Ω·cm.

In Working Example 13, the first crystal grain could be observed. In the first crystal grain, the Ti/Ba elemental ratio a was 5.43, the Mg/Ba elemental ratio b was 0.97, the Mn/Ba elemental ratio g was 0.05, and the Ni/Ba elemental ratio h was 4.12. In addition, the second crystal grain could be observed. In the second crystal grain, the Ti/Ba elemental ratio c was 1.83, the Mg/Ba elemental ratio d was 0.13, the Mn/Ba elemental ratio e was 0.32, and the Ni/Ba elemental ratio f was 0.05. The resistivity ρ was 2.4×10¹⁰ Ω·cm.

In Comparative Example 1, neither the first crystal grain nor the second crystal grain could be observed. The resistivity ρ was 4.4×10⁹ Ω·cm.

In Comparative Example 2, the first crystal grain could not be observed, but the second crystal grain could be observed. In the second crystal grain, the Ti/Ba elemental ratio c was 3.05, the Mg/Ba elemental ratio d was 0.11, the Mn/Ba elemental ratio e was 0.11, and the Ni/Ba elemental ratio f was 0.18. The resistivity ρ was 1.3×10⁹ Ω·cm.

In Comparative Example 3, the first crystal grain could not be observed, but the second crystal grain was observed. In the second crystal grain, the Ti/Ba elemental ratio c was 2.37, the Mg/Ba elemental ratio d was 0.00, the Mn/Ba elemental ratio e was 0.35, and the Ni/Ba elemental ratio f was 0.38. The resistivity ρ was 5.8×10⁹ Ω·cm.

In Comparative Example 4, the first crystal grain could not be observed, but the second crystal grain could be observed. In the second crystal grain, the Ti/Ba elemental ratio c was 2.09, the Mg/Ba elemental ratio d was 0.31, the Mn/Ba elemental ratio e was 0.11, and the Ni/Ba elemental ratio f was 0.22. The resistivity ρ was 1.8×10⁹ Ω·cm.

In Comparative Example 5, the first crystal grain could not be observed, but the second crystal grain could be observed. In the second crystal grain, the Ti/Ba elemental ratio c was 2.16, the Mg/Ba elemental ratio d was 0.13, the Mn/Ba elemental ratio e was 0.12, and the Ni/Ba elemental ratio f was 0.20. The resistivity ρ was 8.0×10⁹ Ω·cm.

The results of Working Examples 1-13 and Comparative Examples 1-5 are shown in Table 2.

TABLE 2

| | FIRST CRYSTAL GRAIN | | | | | SECOND CRYSTAL GRAIN | | | | | |
|---|---|---|---|---|---|---|---|---|---|---|---|
| | PRESENT | | | | | PRESENT | | | | | |
| | OR | a | b | g | h | OR | c | d | e | f | RESISTIVITY |
| | ABSENT | Ti/Ba | Mg/Ba | Mn/Ba | Ni/Ba | ABSENT | Ti/Ba | Mg/Ba | Mn/Ba | Ni/Ba | (Ω · cm) |
| EXAMPLE 1 | PRESENT | 5.32 | 1.00 | 2.28 | 1.76 | PRESENT | 1.62 | 0.14 | 0.14 | 0.18 | 2.9 × 10¹¹ |
| EXAMPLE 2 | PRESENT | 5.60 | 1.11 | 2.85 | 2.02 | PRESENT | 2.16 | 0.13 | 0.12 | 0.20 | 9.5 × 10¹¹ |
| EXAMPLE 3 | PRESENT | 5.66 | 1.14 | 3.42 | 1.01 | PRESENT | 2.31 | 0.12 | 0.03 | 0.37 | 2.1 × 10¹¹ |
| EXAMPLE 4 | PRESENT | 5.71 | 1.10 | 1.71 | 3.03 | ABSENT | — | — | — | — | 4.1 × 10¹⁰ |
| EXAMPLE 5 | PRESENT | 6.85 | 1.08 | 0.15 | 2.10 | PRESENT | 3.23 | 0.11 | 0.12 | 0.19 | 1.5 × 10¹¹ |
| EXAMPLE 6 | PRESENT | 5.82 | 0.54 | 2.74 | 2.04 | PRESENT | 2.20 | 0.03 | 0.12 | 0.16 | 2.0 × 10¹¹ |
| EXAMPLE 7 | PRESENT | 5.71 | 1.21 | 2.72 | 2.02 | PRESENT | 2.09 | 0.16 | 0.11 | 0.24 | 6.6 × 10¹¹ |
| EXAMPLE 8 | PRESENT | 5.60 | 1.44 | 2.91 | 1.94 | PRESENT | 2.03 | 0.29 | 0.11 | 0.24 | 2.9 × 10¹¹ |
| EXAMPLE 9 | PRESENT | 5.15 | 0.78 | 2.88 | 1.96 | PRESENT | 2.18 | 0.12 | 0.12 | 0.22 | 5.1 × 10¹¹ |
| EXAMPLE 10 | PRESENT | 5.26 | 0.92 | 2.89 | 2.00 | PRESENT | 2.24 | 0.12 | 0.12 | 0.22 | 4.9 × 10¹¹ |
| EXAMPLE 11 | PRESENT | 6.72 | 1.33 | 1.91 | 1.98 | PRESENT | 2.22 | 0.12 | 0.12 | 0.22 | 3.9 × 10¹¹ |
| EXAMPLE 12 | PRESENT | 5.38 | 0.92 | 4.13 | 0.07 | PRESENT | 2.76 | 0.12 | 0.02 | 0.32 | 2.3 × 10¹⁰ |
| EXAMPLE 13 | PRESENT | 5.43 | 0.97 | 0.05 | 4.12 | PRESENT | 1.83 | 0.13 | 0.32 | 0.05 | 2.4 × 10¹⁰ |
| COMPARATIVE | ABSENT | — | — | — | — | ABSENT | — | — | — | — | 4.4 × 10⁹ |
| EXAMPLE 1 | | | | | | | | | | | |
| COMPARATIVE | ABSENT | — | — | — | — | PRESENT | 3.05 | 0.11 | 0.11 | 0.18 | 1.3 × 10⁹ |
| EXAMPLE 2 | | | | | | | | | | | |
| COMPARATIVE | ABSENT | — | — | — | — | PRESENT | 2.37 | 0.00 | 0.35 | 0.38 | 5.8 × 10⁹ |
| EXAMPLE 3 | | | | | | | | | | | |
| COMPARATIVE | ABSENT | — | — | — | — | PRESENT | 2.09 | 0.31 | 0.11 | 0.22 | 1.8 × 10⁹ |
| EXAMPLE 4 | | | | | | | | | | | |
| COMPARATIVE | ABSENT | — | — | — | — | PRESENT | 2.16 | 0.13 | 0.12 | 0.20 | 8.0 × 10⁸ |
| EXAMPLE 5 | | | | | | | | | | | |

As shown in Table 2, in Working Examples 1-13, the resistivity ρ (Ω·cm) was on the order of 10¹⁰ or more, and it was confirmed that high insulation resistance was achieved. This is believed to be because the first crystal grain was generated in addition to the main phase crystal grain.

The resistivity of Working Examples 1-3 and 5-11 was higher than that of Working Examples 4, 12, and 13. This is believed to be because in Working Examples 1 to 3 and 5 to 11, the second crystal grain was observed in addition to the first crystal grain, and the second crystal grain satisfied the following conditions: 1.50≤Ti/Ba elemental ratio c≤3.50, 0.03≤Mg/Ba elemental ratio d≤0.30, 0.03≤Mn/Ba elemental ratio e≤0.30, and 0.03≤Ni/Ba elemental ratio f≤0.40.

In addition, for Working Examples 1 to 13, composition evaluation was performed by EDS on the main phase crystal grain contained in the dielectric layer, and it was confirmed that the main phase crystal grain had a core-shell structure.

Although the embodiments of the present invention have been described in detail above, the present invention is not limited to the specific embodiments, and various modifications and changes are possible within the scope of the gist of the present invention described in the claims.

### DESCRIPTION OF REFERENCE CHARACTERS

10 Multilayer chip
11 Dielectric layer
12 Internal electrode layer
13 Cover layer
14 Capacitance section
15 End margin
16 Side margin
20a, 20b External electrode
40 Main phase crystal grain
41 First crystal grain
42 Second crystal grain
43 Third crystal grain
44 Void
51 Ceramic green sheet
52 Internal electrode pattern
53 Dielectric pattern
54 Cover sheet
55 Side margin
100 Multilayer ceramic capacitor

What is claimed is:

1. A dielectric ceramic composition, comprising:
a main phase that contains barium titanate with a perovskite structure;
a first crystal grain that contains barium, titanium and magnesium, and satisfies 5.00≤a≤7.00 and 0.50≤b≤1.50, where a is an elemental ratio of titanium to barium content, and b is an elemental ratio of magnesium to barium content; and
a second crystal grain that contains barium, titanium, magnesium, manganese and nickel, and satisfies 1.50≤c≤3.50, 0.03≤d≤0.30, 0.03≤e≤0.30, and 0.03≤f≤0.40, where an elemental ratio of titanium to barium content is c, an elemental ratio of magnesium to barium content is d, an elemental ratio of manganese to barium content is e, and an elemental ratio of nickel to barium content is f.

2. The dielectric ceramic composition according to claim 1,
wherein the first crystal grain further contains manganese and nickel, and
wherein the first crystal grain satisfies 0.10≤g≤4.00 and 0.10≤h≤4.00, where an elemental ratio of manganese to barium content is g and an elemental ratio of nickel to barium content is h.

3. The dielectric ceramic composition according to claim 1 further comprising:
a third crystal grain that contains at least one of silicate, enstatite, barium magnesium silicate, or fresnoite.

4. The dielectric ceramic composition according to claim 1,
wherein the first crystal grain and the second crystal grain are located in a grain boundary of the main phase.

5. The dielectric ceramic composition according to claim 1,
wherein the first crystal grain and the second crystal grain are located at a triple junction of grain boundaries of the main phase.

6. The dielectric ceramic composition according to claim 3,
wherein the third crystal grain is located in a grain boundary of the main phase.

7. The dielectric ceramic composition according to claim 3,
wherein the third crystal grain is located on a triple junction of grain boundaries of the main phase.

8. The dielectric ceramic composition according to claim 1,
wherein the main phase includes a core portion and a shell portion surrounding the core portion.

9. The dielectric ceramic composition according to claim 8,
wherein the shell portion includes a rare earth element.

10. The dielectric ceramic composition according to claim 1,
wherein an elemental ratio of barium to titanium content is 0.940 or more and 0.980 or less, an elemental ratio of gadolinium to titanium content is 0.005 or more and 0.05 or less, and an elemental ratio of magnesium to titanium content is 0.002 or more and 0.02 or less.

11. A dielectric ceramic composition, comprising:
a main phase having a perovskite structure, containing barium titanate, and having a core portion and a shell portion surrounding the core portion; and
a first crystal grain containing barium, titanium, and magnesium, and satisfies 5.00≤a≤7.00 and 0.50≤b≤1.50, where a is an elemental ratio of titanium to barium content, and b is an elemental ratio of magnesium to barium content.

12. The dielectric ceramic composition according to claim 11,
wherein the first crystal grain further contains manganese and nickel, and
wherein the first crystal grain satisfies 0.10≤g≤4.00 and 0.10≤h≤4.00, where an elemental ratio of manganese to barium content is g and an elemental ratio of nickel to barium content is h.

13. A multilayer ceramic electronic device comprising:
a plurality of dielectric layers including a dielectric ceramic composition according to claim 1;
a plurality of internal electrodes facing each other with the plurality of dielectric layers interposed therebetween; and
external electrodes that are electrically connected to the plurality of internal electrodes, respectively.
